(19) United States
(12) Patent Application Publication
(10) Pub. No.: US 2014/0346103 A1
(43) Pub. Date: Nov. 27, 2014

(54) Filter Base Cap

(71) Applicants: Craig A. Worm, Kearney, NE (US); Steven J. Merritt, Kearney, NE (US)

(72) Inventors: Craig A. Worm, Kearney, NE (US); Steven J. Merritt, Kearney, NE (US)

(73) Assignee: Baldwin Filters, Inc., Kearney, NE (US)

(21) Appl. No.: 14/277,147

(22) Filed: May 14, 2014

Related U.S. Application Data
(60) Provisional application No. 61/826,803, filed on May 23, 2013.

(51) Int. Cl. B01D 35/30; F16N 39/06

(52) U.S. Cl. CPC B01D 35/306; F16N 39/06
USPC 210/235; 137/15.01

(57) ABSTRACT

A filter base cap for sealing and protecting a filter base once a filter has been removed for storage, shipping and transporting of a mechanical system is provided. The filter base cap attaches to the filter base of the system to prevent leakage of residual fluid within the system, such as an engine or other device, after the system has been tested. The filter base cap will provide fluid circulation in the event the mechanical system is started prior to replacing filter base cap with a filter that would otherwise provide fluid flow to the mechanical system.

### CROSS-REFERENCE TO RELATED PATENT APPLICATIONS

This patent application claims the benefit of U.S. Provisional Patent Application No. 61/826,803, filed May 23, 2013, the entire teachings and disclosure of which are incorporated herein by reference thereto.

### FIELD OF THE INVENTION

This invention generally relates to fluid filtration systems and components thereof.

### BACKGROUND OF THE INVENTION

Many mechanical systems utilize fluids for many different uses, such as to power the system, to lubricate the system, or to transmit power. For instance, an engine coupled to a hydraulic ram may use a liquid as fuel to power the engine, a liquid to lubricate moving components within the engine and a liquid to provide pressure to actuate the hydraulic ram.

Many of these systems are produced at a factory that is remote from the location where the system will be placed into service. It is often desired to test the systems prior to shipping the systems and placing them into service to make sure that the systems are operating correctly. Unfortunately, to test these systems, such as the engine or hydraulic ram discussed above, it is required to actually supply the liquids to the mechanical system including the engine and/or hydraulic ram during the testing. More particularly, the engine must be supplied with fuel to power the engine and lubricants to prevent damage to the moving components of the mechanical system during the testing. Further, the hydraulic ram would be supplied with hydraulic fluid to test the operation thereof.

Many of these mechanical systems, such as the engine or hydraulic system, will typically include filtration systems for filtering the fluids during operation, such as a fuel filter system or an oil/lubrication filter system.

Once the mechanical system has been tested and it is determined that it can be shipped, the fluids within the system can be drained so as to avoid spillage within the shipping packaging as well as to prevent migration of the fluid into undesirable locations within the system. Further, when the system includes filtration systems, any replaceable filters within the filtration system may be removed and discarded. Unfortunately, in many situations, all of the fluid cannot be easily removed from the system and some fluid will remain in the system, such as in the engine. When the replaceable filter is removed, this provides a location where the fluid can escape the system and thus leak into the packaging and onto manufacturing floors.

An additional problem in systems with filtration systems with replaceable filters is that the system may be activated prior to the appropriate fluids being supplied to the system. For instance, in the engine example, fuel may be supplied to power the engine but the user may forget to supply the liquid lubricant. If the engine is operated for too long without any lubricant, the engine may be damaged.

The present invention relates to improvements over the current state of the art.

### BRIEF SUMMARY OF THE INVENTION

One embodiment of the invention provides a method of testing and shipping a system that utilizes filtered fluids that are filtered through a removable filter element mounted to a filter base of a filtration system of the system. The method includes testing the system with fluid within the filtration system, the fluid passing through the filter element during testing; after testing, removing the filter element from the filter base; and attaching a filter base cap to the filter base to prevent fluid leakage from the filter base.

In one method, the filter base includes a dirty fluid inlet and a clean fluid outlet. The method further includes fluidly coupling the dirty fluid inlet with the clean fluid outlet by attaching the filter base cap. The filter base cap defines a least part of the fluid flow path between the dirty fluid inlet and clean fluid outlet. Fluid within the system may then pump through the flow path to provide filtered or unfiltered fluid and prevent damage to downstream components of the mechanical system.

In one method, removing the filter element disconnects the filter element from a sealing surface of the filter base and attaching the filter base cap includes sealing the filter base cap to the sealing surface of the filter base.

In one method, sealing is performed by a seal element interposed between the filter base cap and the sealing surface of the filter base.

In one method, the filter base cap includes an outer sidewall defining an internal volume. The filter base cap further includes a plurality of web features (also referred to as spoke features) that segregates the internal volume into a plurality of cavities. The method may further include receiving and storing fluid within the cavities once the filter base cap is attached to the filter base.

In one method, the method includes shipping the system with the filter base cap attached; removing the filter base cap; and attaching a filter element to the filter base. The method may also include checking and adding fluids before activating the mechanical system.

In one method, the method the system is an engine and the filtered fluid is lubrication for the engine.

In one method, the step of attaching the filter base cap to the filter base includes threading the filter base cap to a threaded stud shaft of the filter base.

In one embodiment, a system is provided. The system includes a device that utilizes a fluid, a filtration system, and a filter base cap. The filtration system filters fluid supplied to the device. The filtration system includes a filter base to which a replaceable filter element can be mounted. The filter base has a dirty fluid inlet and a dirty fluid outlet. The filter base cap is removably attachable to the filter base. When the filter base cap is attached to the filter base a fluid flow path is defined between the dirty fluid inlet and the clean fluid outlet. In other embodiments, a flow path need not be formed, but the volume of the filter base cap is large enough to hold residual fluid within the device after the device has been drained and the filter element removed therefrom after initial testing.

In one embodiment, the system further includes a replaceable filter element attachable to the filter base when the filter base cap is removed.

In one embodiment, the filter base includes an axially extending stud shaft and the filter base cap includes an internal volume. The filter base cap defines a central attachment portion that axially receives the stud shaft of the filter base to secure the filter base cap to the filter base.

In one embodiment, the filter base cap defines a plurality of cavities that fluidly communicate with the dirty fluid inlet when the filter base cap is secured to the filter base.

In one embodiment, the filter base includes an axially extending stud shaft that extends axially into one of the cavities when the filter base cap is attached to the filter base. In one more particular embodiment, the cavity that receives the stud shaft has a volume of between about 0.55 and 0.7 cubic inches and is more preferably between 0.58 and 0.65 cubic inches.

In one embodiment, the filter base cap carries a seal element that can be integral or a separate seal that seals between the filter base and the filter base cap.

In one embodiment, the plurality of cavities includes a first plurality of cavities that have a combined volume of between about 0.1 and 0.2 cubic inches and a second plurality of cavities that have a combined volume of between about 0.2 and 0.3 cubic inches.

In one embodiment, the filter base cap includes a central cavity that has a volume of between about 0.55 and 0.7 cubic inches such that the total volume of the cavities is between about 0.85 and 1.2 cubic inches.

In one embodiment, the filter base cap has a volume above the cavities that is generally bound by an annular sidewall of the filter base cap.

In another embodiment, a filter base cap for attachment to a filter base that has a dirty fluid inlet and a clean fluid outlet is provided. The filter base cap includes a main body that defines an open volume, the main body includes a connection region configured for connecting the main body to the filter base and a seal supported by the main body for sealing with a sealing surface of the filter base.

In one embodiment, the main body and open volume is configured such that when the main body is attached to the filter base, the main body provides at least part of a fluid flow path from the dirty fluid inlet to the clean fluid outlet.

In one embodiment, the open volume is segmented into a plurality of cavities. A first one of the cavities includes the connection region and is configured to receive a stud shaft of the filter base when the filter cap is connected to the filter base.

In one embodiment, the open volume is segmented into a plurality of cavities. A first plurality of cavities have a combined volume of between about 0.1 and 0.2 cubic inches and a second plurality of cavities have a combined volume of between about 0.2 and 0.3 cubic inches.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified side view of an embodiment of a mechanical system according to the teachings of the application;

FIG. 2 is a simplified isometric illustration of the system of FIG. 1 including a filter base cap;

FIG. 3 is a cross-sectional illustration of FIG. 2;

FIG. 4 is an exploded illustration of FIG. 2;

FIG. 5 is an exploded cross-sectional illustration of FIG. 2;

FIG. 6 is a top view illustration of the filter base cap of FIG. 2;

FIG. 7 is a cross-sectional illustration of FIG. 6;

FIGS. 8 and 9 illustrate a further embodiment of a filter base cap; and

FIGS. 10-12 illustrate a further embodiment of a filter base cap.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

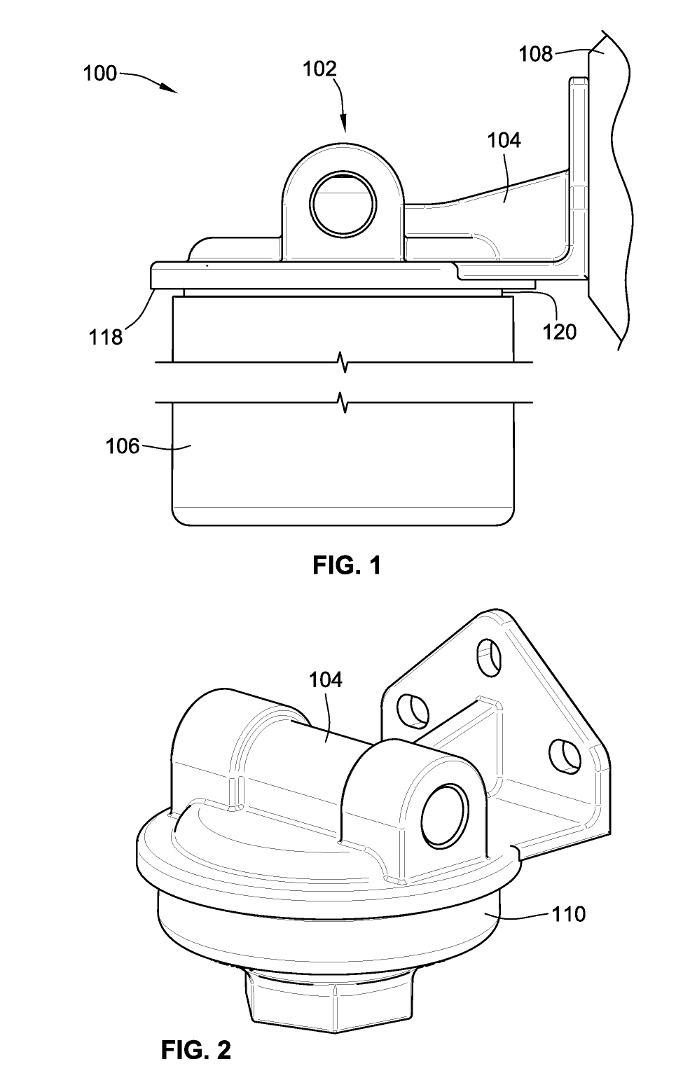

FIG. 1 illustrates a simplified system in the form of an engine 100 that includes a filtration system 102 used for filtering lubrication oil prior to being used by the engine 100. The engine 100 includes a filter base 104 to which a replaceable filter element 106 is attached. The filter base is shown attached to the side of an engine block 108.

In operation, dirty fluid to be filtered will enter the filter base 104, pass through the filter element 106 and cleaned and then exit as clean fluid for use by the engine 100 to lubricate moving parts within the engine 100.

As noted above, systems such as engine 100 are often tested prior to be placed in the field. As such, the manufacturer or assembler may run the engine 100 such that lubrication fluid passes through the filtration system 102 and into engine block 108. After testing, the lubrication fluid will be drained from the engine 100, the filter element 106 may be removed and the engine shipped for being placed into service in the field of use.

To avoid some of the pitfalls of this process, embodiments of the present invention will cap off the filter base 104 prior to shipping the engine 102 so as to avoid fluid leakage. FIG. 2 is a simplified illustration of the filter base 104 having a filter base cap 110 attached thereto.

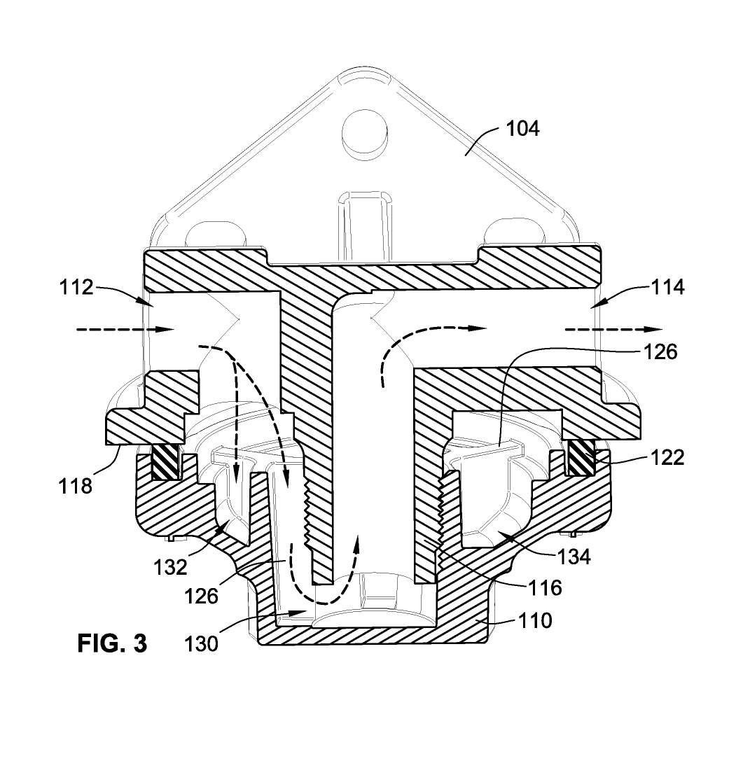

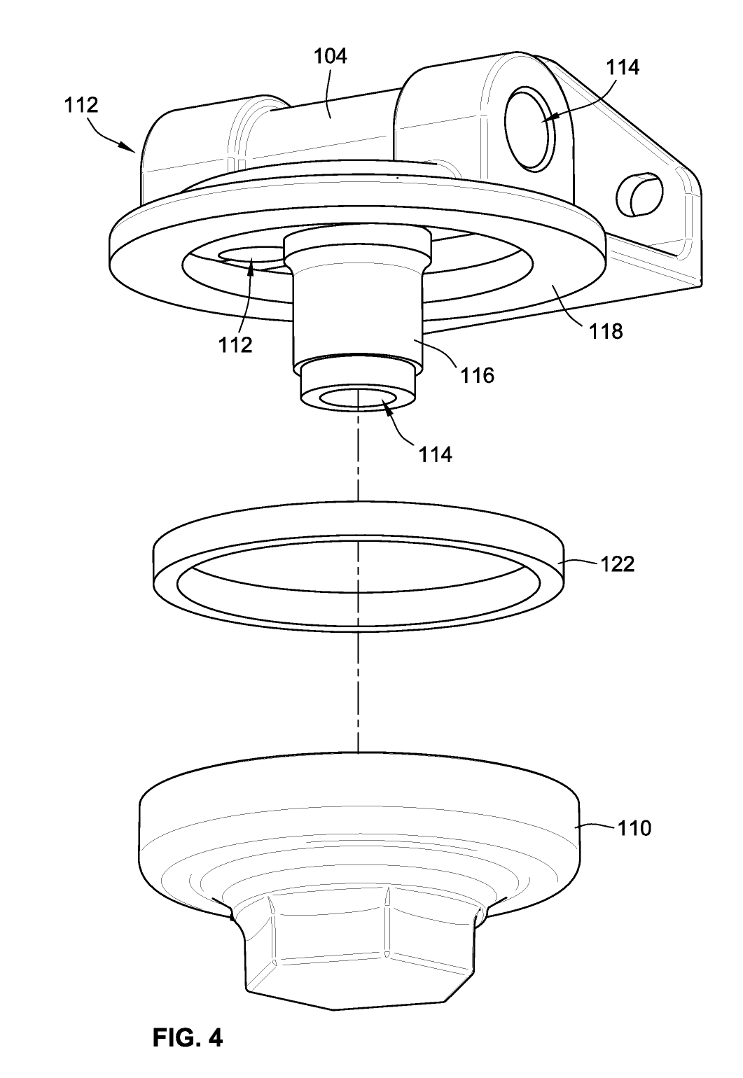

With reference to FIG. 3, the filter base 104 and filter base cap 110 are illustrated in cross-section. The filter base 104 includes a dirty fluid inlet 112 and a clean fluid outlet 114. In other embodiments, the inlet 112 and outlet 114 could be reversed depending on the flow of fluid through the filter element 106.

The filter base 104 includes a central stub shaft that is typically externally threaded for securing the filter element 106 the filter base 104 as illustrated in FIG. 1. The filter base 104 will also typically define one or more seal surfaces 118 to which a filter element 106 will engage and seal to prevent fluid leakage in operation. In this embodiment, the sealing surface 118 is a substantially planar axially facing surface that will form an axial seal with a cooperating seal element 122 of the filter element 106 (see FIG. 1).

With reference to FIG. 3, a seal element 122 is axially positioned between the main body of the filter base cap 110 and the filter base 104. Further, the filter base cap 110 engages the stub shaft 116 to secure the filter base cap 110 thereto. The filter base cap 110 may have one or more threads that engage with mating threads of the stub shaft 116 or may merely be press-fit or friction fit engaged with stub shaft 116. Further, in alternative embodiments, the filter base 104 may have a threaded cavity configured to mate with external threads of a stub shaft of the filter base cap.

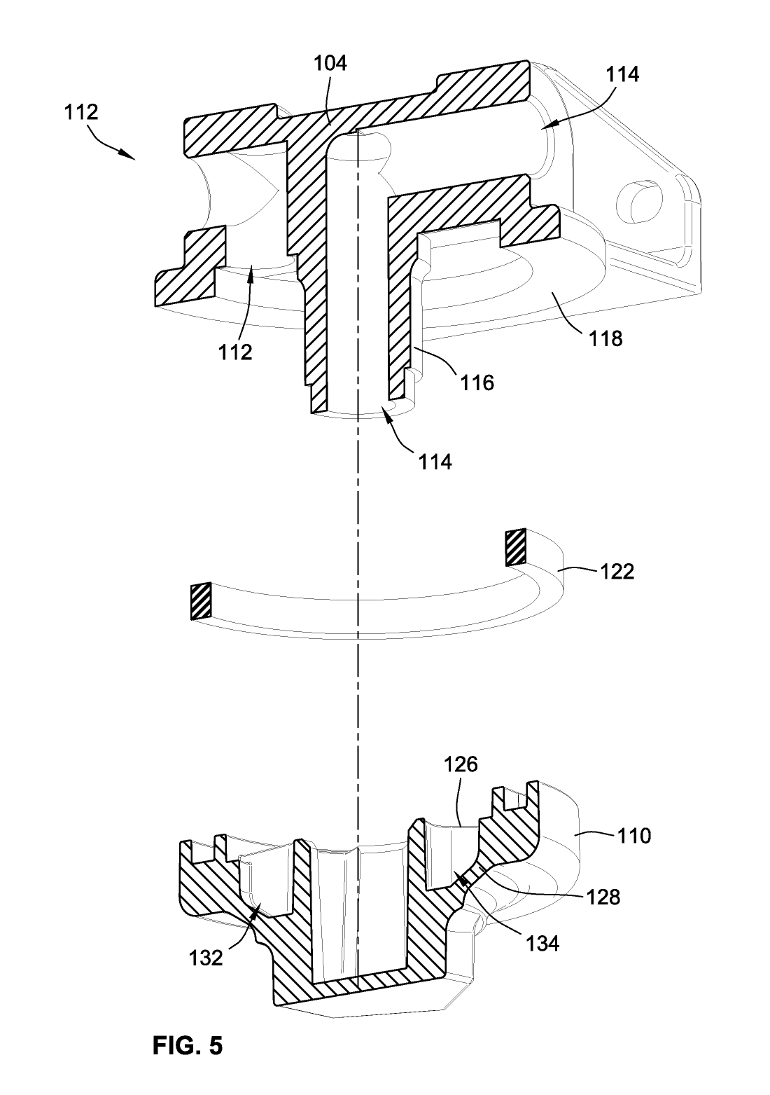

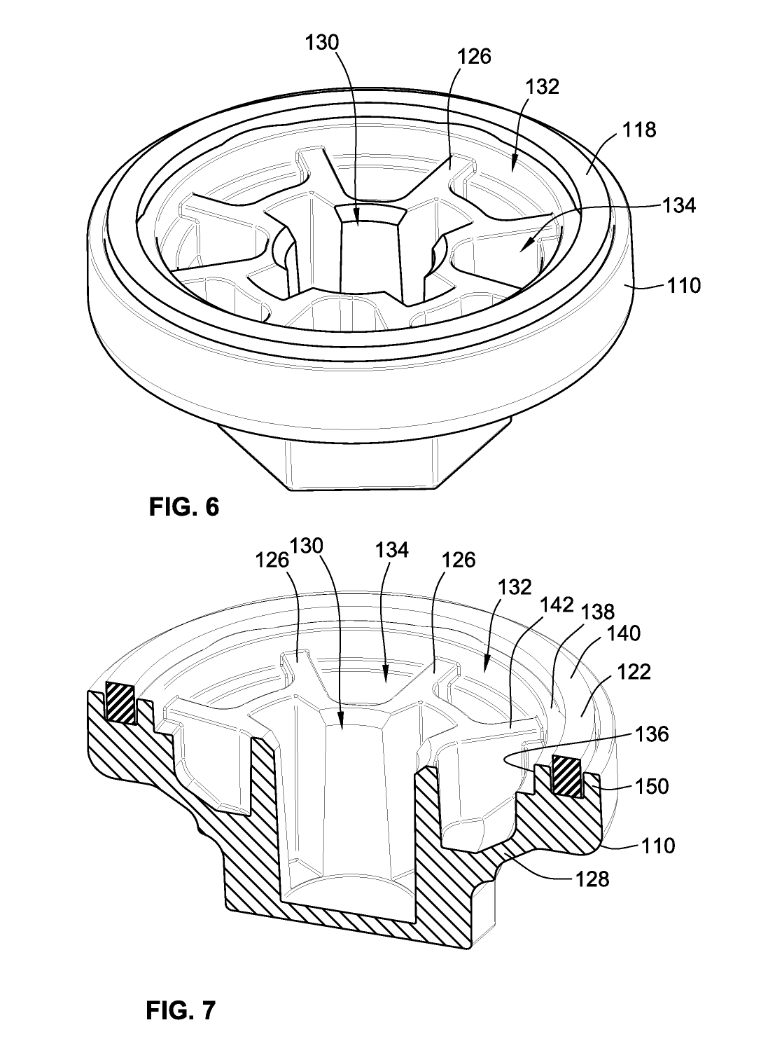

With primary reference to FIGS. 5-7, the filter base cap 110 includes a plurality of interconnected web features 126. The interconnected web features 126 may also be referred to as spoke features. The web features 126 and sidewall 128 and annular sidewall 136 generally define an inner cavity that is segmented into a plurality of cavities that include a central cavity 130, a plurality of small side cavities 132 and a plurality of large side cavities 134. Cavities 130, 132, 134 are recessed below a top end 138 of annular sidewall 136 as well as sealing surface 140 of seal element 122.

With additional reference to FIG. 3, the central cavity 130 receives the stub shaft 116 of the filter base 104 when the filter base cap 110 is attached to the filter base 104. The web features 126 that bound the central cavity 130 may be threaded so as to mate with any threads of the stub shaft 116. Alternatively, the web features 126 may be flexible enough to be press-fit or friction fit engaged with the stub shaft 116.

After an engine or other system has been tested, the filter element 106 will be removed from the stub shaft 116 and the fluid will be substantially drained from the filtration system 102 (see e.g. FIG. 1). The filter base cap 110 will then be attached to the filter base 104 by mounting the filter base cap 110 to the stub shaft 116. Typically, sealing surface 140 of seal element 122 will be axially pressed against sealing surface 118.

With the filter base cap 110 mounted to the filter base 104 (see FIGS. 2 and 3), any fluid that remains within the system, i.e. engine 100, and particularly within the filtration system 102 will be prevented from leaking and can be trapped by the filter base cap 110.

The annular sidewall 136 extends vertically higher than the top end 142 of the web features 126. As such, if the side cavities 132, 134 fill with excess or leftover fluid, the fluid will also flow into central cavity 130. Due to this configuration, all of the cavities 130, 132, 134 are generally in fluid communication with one another when the filter base cap 110 is attached to the filter base 104.

In the illustrated embodiment, the attachment of the filter base cap 110 to the filter base 104 creates a fluid flow path from the dirty fluid inlet 112 to the clean fluid outlet 114, which is at least partially illustrated by flow arrows in FIG. 3. Here, the filter base cap 110 forms at least part of the flow path. This configuration provides the potential benefit that if sufficient fluid remains in the system after testing, the fluid can flow through the filter base cap 110 if the system (i.e. engine) is activated prior to adding of the filter element 106 or the necessary fluid (i.e. lubrication fluid). In this situation, the residual fluid within the system may be able to circulate through the system and reduce the likelihood of damage to the downstream components.

In one embodiment, the cavity defined by the filter base cap 110 is sized to hold at least the volume of residual fluid that will remain within the system after testing procedures. The total volume of the small side cavities 132, in one embodiment, is between 0.1 and 0.2 cubic inches. The total volume of the large side cavities 134, in one embodiment, is between 0.2 and 0.3 cubic inches.

The seal element 122 is located between sidewall 136 and second parallel sidewall 150. The sidewalls 136 and 150 may either or both include radially projections that make the channel formed therebetween narrower for assisting in securing the seal element 122 within the channel.

The filter base cap 110 is preferably a one piece construction formed from molded plastic or metal. As used herein, “one-piece construction” shall not include components independently formed and then secured together such as by welding. One-piece construction shall include a component that is machined from a single piece of material.

Seal element 122 is preferably a plastic, rubber or felt seal element.

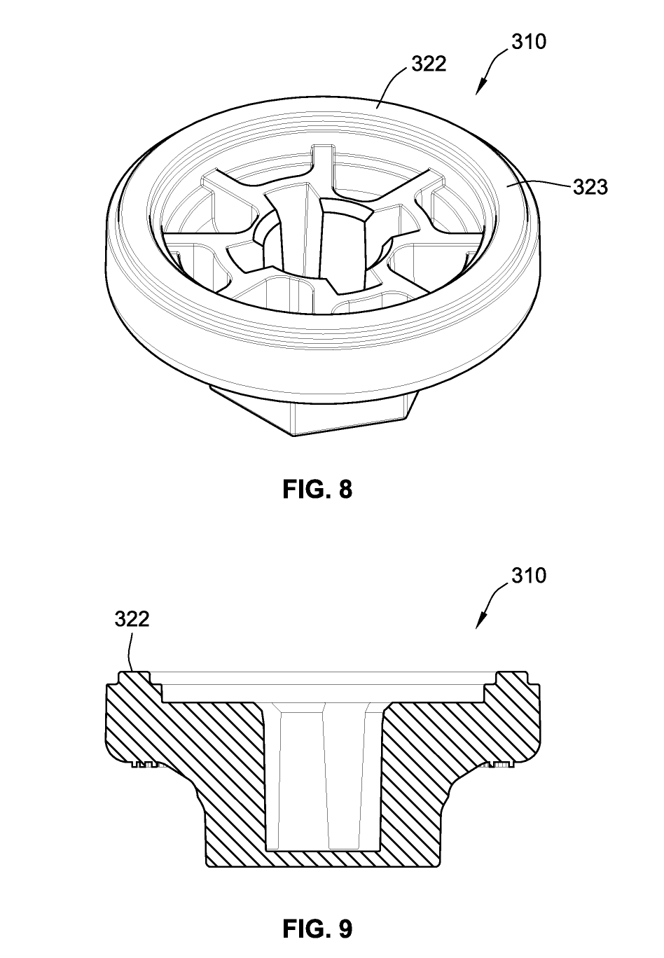

While seal element 122 is illustrated as a separate component, the seal element could be incorporated into the filter base cap. FIGS. 8 and 9 illustrate a further embodiment of a filter base cap 310 similar to filter base cap 110 previously discussed. In this embodiment, the seal element 322 is integrally formed with the rest of the filter base cap 310. The seal element 322 is a raised annular member that defines sealing surfaces 323. In such an embodiment, the filter base cap 110 would be formed from a material that is, at least in part, compliant to provide better sealing engagement with the corresponding sealing surface 118 of the filter base 104.

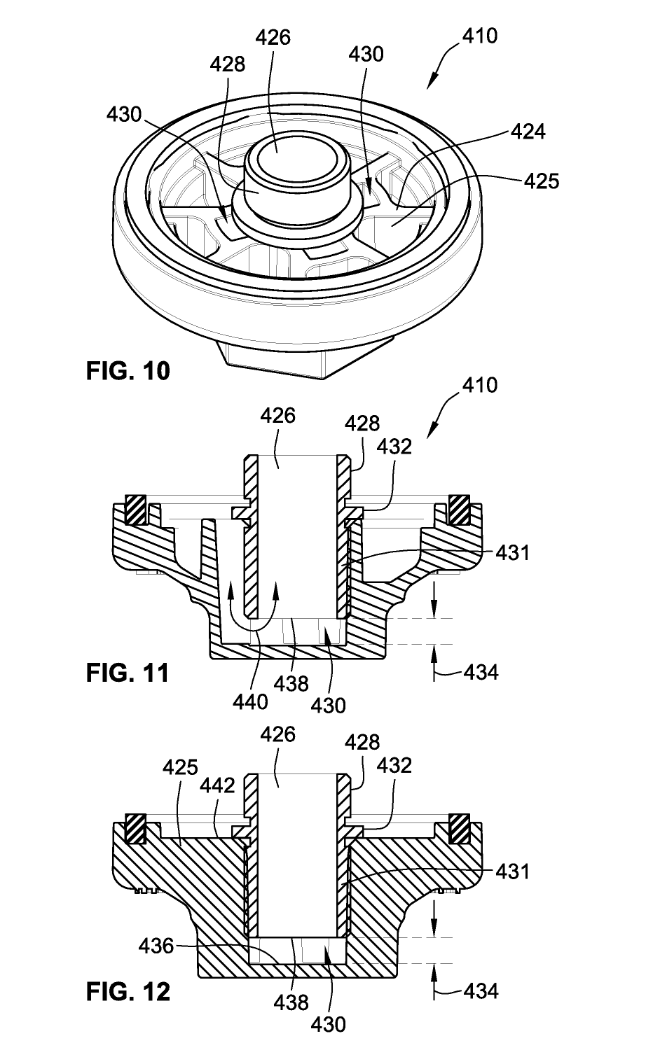

FIGS. 10-12 illustrate a further embodiment of a filter base cap 410. This filter base cap 410 is configured to be utilized in a system where the filter element includes a threaded stub shaft for connecting to a corresponding threaded aperture of a filter base.

In this embodiment, the filter base cap 410 includes an externally threaded stub shaft 426. The tub shaft 426 includes an externally threaded region 428 configured to secure the filter base cap 410 to the corresponding filter base. The stub shaft 426 can be integrally formed with the rest of the filter base cap 410 or a separate component. In this embodiment, the stub shaft 426 is a separate component attached to the rest of the filter base cap 410.

In this embodiment, the stub shaft 426 includes a second threaded region 431 configured to thread into and engage threads in the remainder of the filter base cap 410. These threads would be formed in the central cavity 430. Alternatively, the stub shaft 426 could be press fit, welded or otherwise secured to the rest of the filter base cap 410.

The stub shaft 426 includes a radially extending limiting flange 432 configured to limit the distance into central cavity 430 stub shaft 426 is mounted. The limiting flange 432 axially abuts a top end 442 of webs 425 to limit the insertion of stub shaft 426. This provides an axial gap 434 between bottom surface 436 and the distal end 438 of the stub shaft 426. The gap 434 permits fluid flow, as illustrated by arrow 440 in FIG. 11.

While the filter base 104 that is illustrated is illustrated as a separate component from the engine, it could be formed by the block or sidewall of the engine and need not be a separate component. Further, while the filter base provides connection ports for connecting to the dirty fluid inlet and the clean fluid outlet, these ports could go directly into the engine.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of testing and shipping a system that utilizes filtered fluids that are filtered through a removable filter element mounted to a filter base of a filtration system of the system, the method comprising:
testing the system with fluid within the filtration system, the fluid passing through the filter element during testing;
after testing, removing the filter element from the filter base; and
attaching a filter base cap to the filter base to prevent fluid leakage from the filter base.

2. The method of claim 1, wherein the filter base includes a dirty fluid inlet and a clean fluid outlet, the method further comprising fluidly coupling the dirty fluid inlet with the clean fluid outlet by attaching the filter base cap, the filter base cap defining a least part of the fluid flow path between the dirty fluid inlet and clean fluid outlet.

3. The method of claim 1, wherein the step of removing the filter element disconnects the filter element from a sealing surface of the filter base and wherein attaching the filter base cap includes sealing the filter base cap to the sealing surface of the filter base.

4. The method of claim 3, wherein sealing is performed by a seal element interposed between the filter base cap and the sealing surface of the filter base.

5. The method of claim 1, wherein the filter base cap includes an outer sidewall defining an internal volume, the filter base cap further includes a plurality of web features that segregates the internal volume into a plurality cavities, the method further including receiving and storing fluid within the cavities once the filter base cap is attached to the filter base.

6. The method of claim 1, further comprising:
shipping the system with the filter base cap attached;
removing the filter base cap; and
attaching a filter element to the filter base.

7. The method of claim 1, wherein the system is an engine and the filtered fluid is lubrication for the engine.

8. The method of claim 1, wherein the step of attaching the filter base cap to the filter base includes threadedly securing the filter base cap to a threaded stud shaft of the filter base.

9. A system comprising:
a system for using fluid;
a filtration system for filtering the fluid supplied to the system, the filtration system including a filter base to which a replaceable filter element can be mounted, the filter base having a dirty fluid inlet and a dirty fluid outlet; and
a filter base cap removably attachable to the filter base, wherein when the filter base cap is attached to the filter base a fluid flow path is defined between the dirty fluid inlet and the clean fluid outlet.

10. The system of claim 9, further comprising a replaceable filter element attachable to the filter base when the filter base cap is removed.

11. The system of claim 9, wherein the filter base includes an axially extending stud shaft and the filter base cap includes an internal volume, the filter base cap defining a central attachment portion that axially receives the stud shaft of the filter base to secure the filter base cap to the filter base.

12. The system of claim 9, wherein the filter base cap defines a plurality of cavities that fluidly communicate with the dirty fluid inlet when the filter base cap is secured to the filter base.

13. The system of claim 12, wherein the filter base includes an axially extending stud shaft that extends axially into one of the cavities when the filter base cap is attached to the filter base.

14. The engine system of claim 9, wherein the filter base cap carries a seal element that seals between the filter base and the filter base cap.

15. The system of claim 12, wherein the plurality of cavities includes a first plurality of cavities that have a combined volume of between about 0.1 and 0.2 cubic inches and a second plurality of cavities that have a combined volume of between about 0.2 and 0.3 cubic inches.

16. The system of claim 15, further comprising a central cavity that has a volume of between about 0.55 and 0.7 cubic inches such that the total volume of the cavities is between about 0.85 and 1.2 cubic inches.

17. The system of claim 16, wherein the filter base cap has a volume above the cavities that is generally bound by an annular sidewall of the filter base cap.

18. A filter base cap for attachment to a filter base that has a dirty fluid inlet and a clean fluid outlet, the filter base cap comprising:
a main body that defines an open volume, the main body includes a connection region configured for connecting the main body to the filter base;
a seal supported by the main body for sealing with a sealing surface of the filter base.

19. The filter base cap of claim 18, wherein the main body and open volume is configured such that when the main body is attached to the filter base, the main body provides at least part of a fluid flow path from the dirty fluid inlet to the clean fluid outlet.

20. The filter base cap of claim 18, wherein the open volume is segmented into a plurality of cavities, a first one of the cavities includes the connection region and is configured to receive a stud shaft of the filter base when the filter cap is connected to the filter base.

21. The filter base cap of claim 18, wherein the open volume is segmented into a plurality of cavities, a first plurality of cavities have a combined volume of between about 0.1 and 0.2 cubic inches and a second plurality of cavities have a combined volume of between about 0.2 and 0.3 cubic inches.
